(19) United States
(12) Patent Application Publication
(10) Pub. No.: US 2021/0124069 A1
(43) Pub. Date: Apr. 29, 2021

(54) UNDERGROUND TUNNELING DETECTION SYSTEMS AND METHODS

(71) Applicant: THE BOEING COMPANY, CHICAGO, IL (US)

(72) Inventors: Andrew Vincent Born, Los Alamitos, CA (US); Christopher K. Burns, Leesburg, VA (US); James Thomas Beasley, Huntsville, AL (US); Thomas Curtis Anderson, Huntsville, AL (US)

(73) Assignee: THE BOEING COMPANY, CHICAGO, IL (US)

(21) Appl. No.: 16/662,492

(22) Filed: Oct. 24, 2019

(51) Int. Cl. G01V 1/00; G10L 25/51

(52) U.S. Cl. CPC G01V 1/001; G10L 25/51

(57) ABSTRACT

An underground tunneling detection system and method includes a tunneling detection control unit that receives one or more sound detection signals including a sound signature output by a component that is underground and at or proximate to a location. The tunneling detection control unit compares the sound signature to sound signature data. The tunneling detection control unit determines that the sound signature is non-tunneling activity in response to the sound signature matching a non-tunneling portion of the sound signature data. The tunneling detection control unit determines that the sound signature is tunneling activity in response to the sound signature matching a tunneling portion of the sound signature data. The tunneling detection control unit determines a similarity metric between the sound signature and one or both of the non-tunneling portion of the sound signature data or the tunneling portion of the sound signature data in response to the sound signature differing from the sound signature data.

### FIELD OF EMBODIMENTS OF THE DISCLOSURE

Embodiments of the present disclosure generally relate to underground tunneling detection systems and methods, such as may be used to detect tunneling activity in relation to a monitored location.

### BACKGROUND OF THE DISCLOSURE

Various locations, such as banks, casinos, prisons, military installations, and the like, are monitored for unauthorized intrusion. For example, cameras may be positioned throughout a location to detect movement. Existing monitoring systems are typically able to detect surface and aerial intrusions in real time, but are generally unable to detect intrusions underneath a location in real time. Accordingly, the locations may be vulnerable to intrusion, infiltration, extraction, and the like via underground tunneling.

Known perimeter intrusion detection systems (PIDS) are typically configured to detect intrusion from the air or from the surface (for example, driving, running, climbing, or the like). Certain PIDS use radar or smart fences to detect moving objects in the air and on the ground, then use a secondary sensor (for example, a camera) for verification. However, cameras are generally unable to acquire images through opaque structures, such as rock, dirt, and the like which forms ground in and around a location.

Certain known PIDS include buried geophones, which acquire underground sounds, which are then analyzed. However, such PIDS typically only recognize sound signals for which there is a perfect match with a watch list of signals. The PIDS are typically unable to discern individual signals when multiple signals are superimposed over each other. Further, known PIDS may be undermined due to loud masking noises (for example, manufacturing machinery) that are used to distract and hide a fainter drilling noise.

### SUMMARY OF THE DISCLOSURE

A need exists for a system and method for detecting underground tunneling activity in relation to a location in real time. Further, a need exists for a system and method for accurately and efficiently discerning actual underground threats from non-threats (for example, false alarms and nuisance alarms).

With those needs in mind, certain embodiments of the present disclosure provide an underground tunneling detection system that includes a tunneling detection control unit that receives one or more sound detection signals (including a sound signature) output by a component that is underground and at or proximate to a location. The tunneling detection control unit compares the sound signature to sound signature data. The tunneling detection control unit determines that the sound signature is either non-tunneling activity (in response to the sound signature matching a non-tunneling portion of the sound signature data), or tunneling activity (in response to the sound signature matching a tunneling portion of the sound signature data). The tunneling detection control unit determines a similarity metric between the sound signature and one or both of the non-tunneling portion of the sound signature data or the tunneling portion of the sound signature data in response to the sound signature differing from the sound signature data.

In at least one embodiment, the underground tunneling detection system also includes a seismic exciter and receiver in communication with the tunneling detection control unit. The tunneling detection control unit is configured to operate the seismic exciter to emit a seismic pulse (for example, a dropped weight, a gun blast, or the like) into the ground. The seismic pulse is detected by the receiver. As an example, the tunneling detection control unit operates the seismic exciter to emit the seismic pulse into the ground in response to the similarity metric exceeding a tunneling verification threshold (for example, a reasonable suspicion that there is active tunneling as determined through analysis, and therefore generate the seismic pulse as a secondary method to verify).

In at least one embodiment, the tunneling detection control unit receives a verification signal from the receiver. The verification signal is indicative of features of the ground as determined by the seismic pulse received by the receiver. The tunneling detection control unit compares the verification signal to underground data of the location. The tunneling detection control unit determines tunneling activity in response to the verification signal differing from the underground data.

In at least one embodiment, the underground tunneling detection system also includes a location underground database in communication with the tunneling detection control unit. The location underground database may store the underground data.

In at least one embodiment, the underground tunneling detection system also includes a sounds database in communication with the tunneling detection control unit. The sound signature data may be stored in the sounds database.

In at least one embodiment, the sound signature data is produced at a testing facility.

The underground tunneling detection system may also include a user interface in communication with the tunneling detection control unit. The tunneling detection control unit may output alert signals to the user interface.

Certain embodiments of the present disclosure provide an underground tunneling detection method that includes receiving or detecting (such as by a tunneling detection control unit) one or more sound detection signals including a sound signature output by a component that is underground and at or proximate to a location, comparing (such as by the tunneling detection control unit) the sound signature to sound signature data, determining (such as by the tunneling detection control unit) that the sound signature is non-tunneling activity in response to the sound signature matching a non-tunneling portion of the sound signature data, determining (such as by the tunneling detection control unit) that the sound signature is tunneling activity in response to the sound signature matching a tunneling portion of the sound signature data, and determining (such as by the tunneling detection control unit) a similarity metric between the sound signature and one or both of the non-tunneling portion of the sound signature data or the tunneling portion of the sound signature data in response to the sound signature differing from the sound signature data.

### BRIEF DESCRIPTION OF THE DRAWINGS

FIG. 1 illustrates a schematic diagram of an underground tunneling detection system, according to an embodiment of the present disclosure.

FIG. 2 illustrates a schematic diagram of a testing facility, according to an embodiment of the present disclosure.

FIG. 3 illustrates a flow chart of an underground tunneling method, according to an embodiment of the present disclosure.

### DETAILED DESCRIPTION OF THE DISCLOSURE

The foregoing summary, as well as the following detailed description of certain embodiments, will be better understood when read in conjunction with the appended drawings. As used herein, an element or step recited in the singular and preceded by the word “a” or “an” should be understood as not necessarily excluding the plural of the elements or steps. Further, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional elements not having that property.

Certain embodiments of the present disclosure provide underground tunneling detection systems and methods that are configured to detect, locate, and characterize underground tunneling activity, as part of a perimeter intrusion detection system (PIDS). The underground tunneling detection systems and methods accurately detect underground activity, and have a low false alarm rate and a low nuisance alarm rate (such as sounds caused by vehicles traveling on the ground). The underground tunneling detection systems and methods are automated to rapidly alert individuals of any intrusions, provide locations and characteristics of the detection, and are adaptable to different types of ground soils (for example, rocky, clay, sand, etc.).

In an at least one embodiment, a sound signature (or a combined or total sound signature) detected by a sensor may include multiple individual signatures (for example, manufacturing machinery, farming tractors, highway traffic, and/or the like). The total sound signature may or may not also include tunneling or drilling sounds. Embodiments of the present disclosure are configured to detect tunneling activity within a total sound signature that includes at least one tunneling signature and numerous non-tunneling signatures. Embodiments of the present disclosure determine that there is not tunneling activity if there is no tunneling signature within a total sound signature.

Certain embodiments of the present disclosure provide an underground tunneling detection method that includes receiving or detecting (such as by a tunneling detection control unit) one or more sound detection signals including a sound signature output by at least one component that is underground and at or proximate to a location, communicating the detected signal or message from the component(s) to the tunneling detection control unit, comparing (such as by the tunneling detection control unit) the sound signature to sound signature data, determining (such as by the tunneling detection control unit) that each of the sound signatures is non-tunneling activity in response to each sound signature matching a non-tunneling portion of the sound signature data, determining (such as by the tunneling detection control unit) that one or more of the sound signature(s) is tunneling activity in response to the sound signature matching a tunneling portion of the sound signature data, and determining (such as by the tunneling detection control unit) a similarity metric between the sound signature and one or both of the non-tunneling portion of the sound signature data or the tunneling portion of the sound signature data in response to the sound signature differing from the sound signature data. In at least one embodiment, the method also includes alerting the user with the results (tunneling or not tunneling), as well as a metric for the user to initiate an active mode (such as through a seismic exciter, for example) to verify whether tunneling activity exists, determining (such as by the tunneling detection control unit) a similarity metric between the measured underground terrain and the historical underground terrain in response to the measured underground terrain differing from the historical underground terrain database, and alerting the user with the results (tunneling or not tunneling), as well as a metric for the user to initiate the active mode to verify whether tunneling activity exists.

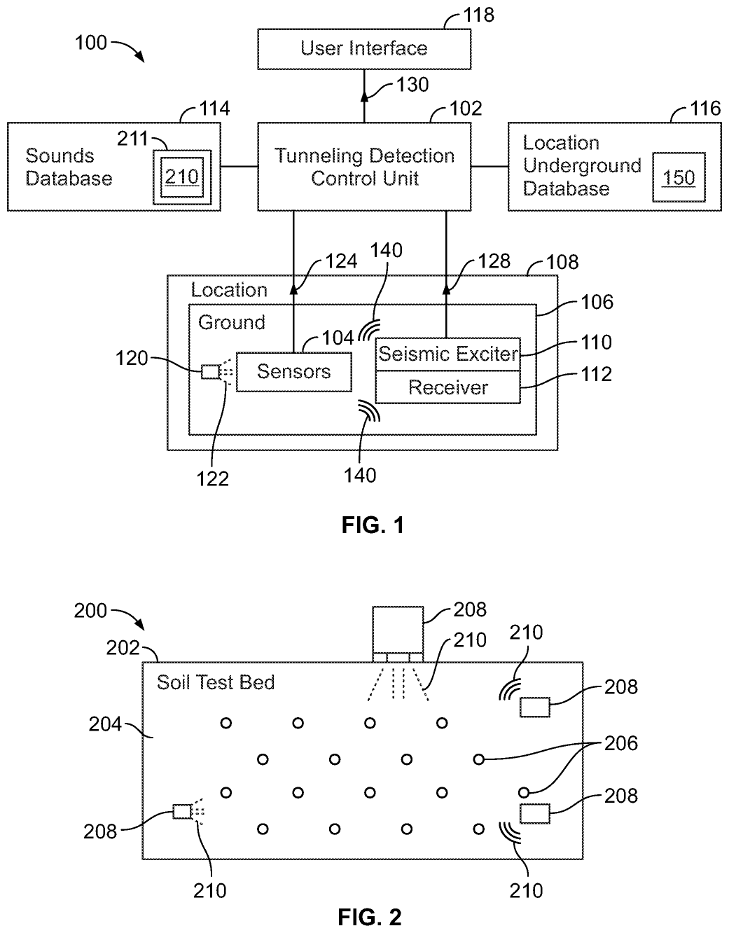

FIG. 1 illustrates a schematic diagram of an underground tunneling detection system 100, according to an embodiment of the present disclosure. The underground tunneling detection system 100 includes a tunneling detection control unit 102 that is in communication with one or more sensors 104 within ground 106 (that is, underground) at a location 108. The location 108 may be any location that is to be monitored for underground tunneling activity, such as a military installation, a prison, a bank, a casino, a private residence, or the like. In at least one embodiment, the tunneling detection control unit 102 is at the location 108. In at least one other embodiment, the tunneling detection control unit 102 is remote from the location 108, such as within a central monitoring station.

The tunneling detection control unit 102 is in communication with the sensors 104 through one or more wired or wireless connections. For example, the sensors 104 and the tunneling detection control unit 102 may communicate through wired signals, wireless radio frequency signals, or the like. The sensors 104 may be or include geophones, unattended ground sensors, microphones, broadband seismometers, sono-buoys, pressure transducers, underground lossy coaxial cables, and/or the like.

The sensors 104 may be dispersed within the ground 106 at varying depths. For example, one or more of the sensors 104 may be between 0-20 feet underground, one or more sensors 104 may be between 20-40 feet underground, one or more sensors 104 may be between 40-60 feet underground, and the like. The sensors 104 may be located under the ground 106 at or proximate (such as within 10 feet) the perimeter of the location. In at least one embodiment, at least one of the sensors 104 may be located further into the location than the perimeter. In at least one embodiment, the sensors 104 may include at least one sensor on or above the ground. For example, one or more cameras, a light detection and ranging (LIDAR) system, and/or the like may provide verification sensors.

In at least one embodiment, the tunneling detection control unit 102 is also in communication with a seismic exciter 110 and a receiver 112 through one or more wired or wireless connections. The seismic exciter 110 and the receiver 112 may be under the ground 106, on the ground 106, or above the ground 106. The seismic exciter 110 is configured to emit a seismic pulse into the ground 106. The receiver 112 is configured to receive reflected seismic energy from the seismic pulse as reflected off features within the ground 106. As examples, the seismic exciter 110 may be a gun, cannon, or explosive-discharger that emits a seismic pulse as it is activated (for example, fired), one or more components (such as large, heavy (for example, 1000 pound) plates) that are dropped onto the ground 106 to generate the seismic pulse, vibration emission devices, and/or the like. In at least one embodiment, the receiver 112 may be a sensor, such as one or more of the sensors 104.

The tunneling detection control unit 102 is also in communication with a sounds database 114, such as through one or more wired or wireless connections. The tunneling detection control unit 102 and the sounds database 114 may be at a common location, or may be remotely located from one another. The sounds database 114 stores sound signature data, which includes tunneling activity, nuisance activity, and the like. The sound data is generated and stored in the sounds database 114 through sound tests conducted at a testing facility, as described herein.

In at least one embodiment, the tunneling detection control unit 102 is also in communication with a location underground database 116, such as through one or more wired or wireless connections. The tunneling detection control unit 102 and the location underground database 116 may be at a common location, or may be remotely located from one another. The location underground database 116 stores underground data regarding the location 108. The underground data includes information regarding the nature of the location underneath the location and/or areas proximate to the location (such as underground areas within 100 feet or more of the location), such as may be determined via underground surveys and seismic detection.

The tunneling detection control unit 102 is also in communication with a user interface 118, such as through one or more wired or wireless connections. The tunneling detection control unit 102 may be at the same location with the user interface 118, or may be remotely located therefrom. In at least one embodiment, the user interface 118 is at the location 108. The user interface 118 may be part of a computing device, and may include a monitor and speaker.

FIG. 2 illustrates a schematic diagram of a testing facility 200, according to an embodiment of the present disclosure. The testing facility 200 is configured to be used to produce sound data, which is stored in sounds database 114 (shown in FIG. 1). The testing facility 200 includes a soil test bed 202 that retains various types of soil 204. A plurality of sensors 206 (such as may be the same or similar to the sensors 104 shown in FIG. 1) are dispersed throughout the soil test bed 202.

Various components 208 that generate sound signatures (such as noises) are positioned within the soil test bed 202. The components 208 include tunneling devices (such as drills, picks, shovels, or the like), animal mimicking devices, mining devices, fracking devices, and various other devices, structures, or the like that are configured to generate characteristic sound signatures.

As an example, the components 208 include tunneling devices that are configured to generate sound signatures 210 that are characteristic of tunneling activity. The sensors 206 detect the sound signatures 210. The sound signatures 210 indicative of tunneling activity are stored in the sounds database 114 (shown in FIG. 1) as sound signature data 211 (shown in FIG. 1).

As another example, the components 208 include nuisance devices (that is, devices other than tunneling devices) that are configured to generate sound signatures 210 that are characteristic of non-tunneling activity (that is, nuisance activity). For example, the sensors 206 detect such sound signatures 210 of nuisance activity, which are also stored in the sounds database 114.

As another example, the components 208 include vehicles on the ground. Operation of the vehicles generate sound signatures 210 that are detected by the sensors 206. The sound signatures 210 from the vehicles are characterized as non-tunneling, nuisance activity.

Various tests with various components 208 are conducted. Each component 208 is determined to be a tunneling device, or a non-tunneling device, and the sound signatures 210 generated therefrom and detected by the sensors 206 are characterized accordingly. The sound signatures 210 detected by the sensors 206 and characterized as either tunneling activity or non-tunneling activity are stored in the sounds database 114 as sound signature data 211.

The sensors 206 are stored at varying depths and locations within the soil test bed to detect the various sound signatures 210 from the components 208 (both tunneling components and non-tunneling, nuisance components). As such, the sound signatures 210 at different distances above, below, and at the level of the components 208 are detected by the sensors 206 at the testing facility. Accordingly, the sound signatures 210, whether indicative of tunneling activity or non-tunneling activity, are detected from the sensors 206 at varying distances and depths in relation to the components 208.

As can be appreciated, the ground at different locations may differ. For example, the soil at a location may include one or more or rocks, clay, sand, dirt, and the like. Accordingly, the soil 204 at the test facility 200 may be changed and tests conducted for various types of soil and soil combinations. Referring to FIGS. 1 and 2, the soil 204 at the testing facility 200 may be configured the same as the soil of the ground 106 at the location 108, in order to ensure accurate detection of sounds generated within the ground 106 at the location 108.

Further, the soil 204 at the test facility 200 may be varied in terms of moisture content. That is, various sound tests may be performed with different levels of moisture, so as to determine the sound signatures 210 at different moisture levels, as the sound signatures 210 at a first moisture level may differ from the same sound signatures 210 at a second moisture level.

Referring again to FIG. 1, in operation, a component 120 outputs (for example, emits, generates, produces, or the like) a sound signature 122 underneath the ground 106 at or proximate (such as within 500 feet) of the location 108. The sensors 104 detect the sound signature 122, and the position of the component 120 emitting the sound signature 122, such as via triangulation in relation to multiple sensors 104. The sensors 104 output sound detection signals 124 that are received by the tunneling detection control unit 102. The tunneling detection control unit 102 compares the received sound detection signals 124 with the sound signatures 210 stored in the sounds database 114. If the sound signature 122 as included in the sound detection signals 124 received from the sensors 104 matches stored nuisance sound signatures 210 (for example, sound signatures indicative of non-tunneling activity, such as animal activity, on-ground vehicles, acceptable mining activity, fracking activity, or other such non-tunneling activity) within the sound signature data 211, then the tunneling detection control unit 102 determines that the component 120 is not conducting tunneling activity. In this case, the tunneling detection control unit 102 may refrain from sending an alert signal to the user interface 118, or may output an alert signal 130 indicating non-tunneling activity, which may be shown or broadcast on the user interface 118.

If, however, the sound signature 122 as included in the sound detection signals 124 received from the sensors 104 matches stored tunneling sound signatures 210 (for example, sound signatures indicative of tunneling activity, such caused by drilling, picking, shoveling, or the like) within the sound signature data 211, then the tunneling detection control unit 102 determines that the component 120 is conducting tunneling activity. In this case, the tunneling detection control unit 102 sends an alert signal 130 to the user interface 118 indicating tunneling or threat activity, which may be shown or broadcast on the user interface 118.

If, however, the sound signature 122 as included in the sound detection signals 124 received from the sensors 104 does not directly match stored tunneling or non-tunneling sound signatures 210 stored within the sound signature data 211, the tunneling detection control unit 102 determines a similarity metric between the sound signature 122 and one or more of the sound signatures 210 of the sound signature data 211 stored in the sounds database 114. For example, the sound signature 122 may be within a certain percentage of a frequency of either a stored sound signature 210 within the sounds database 114 of tunneling activity or non-tunneling activity. If the sound signature 122 is more similar to a sound signature 210 of non-tunneling activity, the tunneling detection control unit 102 determines a similarity metric in relation to the sound signature 210 (such as 90% or more of the frequency of the stored sound signature). In this case, the tunneling detection control unit 102 outputs an alert signal 130 to the user interface 118 indicating that the component 120 is within a determined percentage of known non-tunneling activity, as stored within the sounds database 114. The alert signal may include a confidence measure that the detected sound signature 122 is non-tunneling activity, such as “90% confidence of non-tunneling activity.”

Similarly, if the sound signature 122 is more similar to a sound signature 210 of tunneling activity, the tunneling detection control unit 102 determines a similarity metric in relation to the sound signature 210 (such as 90% or more of the frequency of the stored sound signature). In this case, the tunneling detection control unit 102 outputs an alert signal 130 to the user interface 118 indicating that the component 120 is within a determined percentage of known tunneling activity, as stored within the sounds database 114. The alert signal may include a confidence measure that the detected sound signature 122 is tunneling activity, such as “90% confidence of non-tunneling activity.”

The detected sound signature 122 may not be a direct match with sound signatures 210 of non-tunneling activity or tunneling activity, as stored in the sounds database 114. As such, the tunneling detection control unit 102 outputs an alert signal 130 to the user interface 118 indicating the nature of the sound signature 122 as generated by the component 120, as well as the location of the component 120 within the ground 106, as detected by the sensors 104. The tunneling detection control unit 102 determines a similarity metric between the detected sound signature 122 and one or more sound signatures 210 as stored in the sounds database 114. The similarity metric indicates how close (such as via a percentage of a frequency) the detected sound signature 122 is to one or more of the sound signatures 210 stored in the sounds database 114. The similarity metric may be shown on the user interface 118.

In at least one embodiment, the tunneling detection control unit 102 may also determine a confidence measure that the detected sound signature 122 is tunneling or non-tunneling activity. For example, the tunneling detection control unit 102 may determine varying levels of confidence (whether with respect to tunneling activity or non-tunneling activity) based on predetermined thresholds. As examples, a similarity metric of 95% or more of frequency to a sound signature 210 stored in the sounds database 114 may correlate with a very high degree of confidence, a similarity metric between 80%-95% may correlate with a high degree of confidence, a similarity metric between 50-80% may correlate with a moderate degree of confidence, a similarly metric between less than 50% may correlate with a low degree of confidence, and/or the like. It is to be understood that the percentages noted are merely examples, and the degrees of confidence may be correlated with percentages that are greater or less than shown, and/or with other parameters, such as characteristic features of amplitudes, frequencies, waves, or the like.

In at least one embodiment, in response to the tunneling detection control unit 102 detecting a sound signature 122 having a similarity metric that exceeds a tunneling verification threshold (for example, the sound signature 122 differs from, but is relatively close to (such as being 95% or more similar) a sound signature 210 of known tunneling activity as stored in the sounds database 114), the tunneling detection operates the seismic exciter 110 to emit a seismic pulse 140 into the ground 106. The seismic pulse 140 is emitted by the seismic exciter 110 and is reflected back to the receiver 112. The receiver 112 then outputs a verification signal 128 indicative of features of the ground 106 as determined by the reflected seismic pulse 140 to the tunneling detection control unit 102.

The tunneling detection control unit 102 then compares the verification signal 128 (that is, data within the verification signal 128) with stored underground data 150 (for example, a three-dimensional underground map of the location, such as determined via previous mapping and/or verification signals 128) of the location 108, as stored in the location underground database 116. If the verification signal 128 as received by the tunneling detection control unit 102 is similar to (for example, matches or there are no new voids larger than 2 cubic feet) the underground data 150 stored in the location underground database 116, the tunneling detection control unit 102 determines that the sound signature 122 does not represent tunneling activity. The tunneling detection control unit 102 may then output a verification message (such as through an alert signal 130) to the user interface 118 indicating that the sound signature 122 does not represent tunneling activity.

If, however, the verification signal 128 as received by the tunneling detection control unit 102 differs from (for example, at least one void within the ground 106 larger than 2 cubic feet) the underground data 150 stored in the location underground database 116, the tunneling detection control unit 102 determines that the sound signature 122 represents tunneling activity. The tunneling detection control unit 102 then outputs an alert signal 130 to the user interface 118 indicating that the sound signature 122 is indicative of tunneling activity.

In at least one embodiment, the tunneling detection control unit 102 automatically operates the seismic exciter 110 to emit the seismic pulse 140 into the ground 106. Optionally, in response to detecting a sound signature 122 that exceeds the tunneling verification threshold, the tunneling detection control unit 102 may prompt an operator whether or not to operate the seismic exciter 110, such as via the user interface 118.

In at least one embodiment, additional sensors, such as cameras, radar systems, LIDAR systems, and/or the like, may be used as redundancy checks. For example, the cameras, radar systems, or LIDAR systems may be used to detect vibrations at the surface of the ground 106 to confirm sound signatures 122 as detected by the sensors 104.

As described herein, the underground tunneling detection system 100 includes the tunneling detection control unit 102, which receives one or more sound detection signals 124 including (for example indicative of) the sound signature 122 output by the component 120, which is underground and at or proximate to (for example, within 500 feet of) the location 108. The tunneling detection control unit 102 compares the sound signature 122 to the sound signature data 211. The tunneling detection control unit 102 determines that the sound signature 122 is non-tunneling (for example, nuisance) activity in response to the sound signature 122 matching a non-tunneling portion of the sound signature data 211. The tunneling detection control unit 102 determines that the sound signature 122 is tunneling activity in response to the sound signature 122 matching a tunneling portion of the sound signature data 211. Further, the tunneling detection control unit 102 determines a similarity metric between the sound signature 122 and one or both of the non-tunneling portion of the sound signature data 211 or the tunneling portion of the sound signature data 211 in response to the sound signature 122 differing from the sound signature data 211.

As used herein, the term “control unit,” “unit,” “central processing unit,” “CPU,” “computer,” or the like may include any processor-based or microprocessor-based system including systems using microcontrollers, reduced instruction set computers (RISC), application-specific integrated circuits (ASICs), logic circuits, and any other circuit or processor including hardware, software, or a combination thereof capable of executing the functions described herein. Such are exemplary only, and are thus not intended to limit in any way the definition and/or meaning of such terms. For example, the tunneling detection control unit 102 may be or include one or more processors that are configured to control operation thereof.

The tunneling detection control unit 102 is configured to execute a set of instructions that are stored in one or more storage elements (such as one or more memories), in order to process data. For example, the tunneling detection control unit 102 may include or be coupled to one or more memories. The storage elements may also store data or other information as desired or needed. The storage elements may be in the form of an information source or a physical memory element within a processing machine.

The set of instructions may include various commands that instruct the tunneling detection control unit 102 as a processing machine to perform specific operations such as the methods and processes of the various embodiments of the subject matter described herein. The set of instructions may be in the form of a software program. The software may be in various forms such as system software or application software. Further, the software may be in the form of a collection of separate programs, a program subset within a larger program or a portion of a program. The software may also include modular programming in the form of object-oriented programming. The processing of input data by the processing machine may be in response to user commands, or in response to results of previous processing, or in response to a request made by another processing machine.

The diagrams of embodiments herein may illustrate one or more control or processing units, such as the tunneling detection control unit 102. It is to be understood that the processing or control units may represent electronic circuits, circuitry, or portions thereof that may be implemented as hardware with associated instructions (e.g., software stored on a tangible and non-transitory computer readable storage medium, such as a computer hard drive, ROM, RAM, or the like) that perform the operations described herein. The hardware may include state machine circuitry hardwired to perform the functions described herein. Optionally, the hardware may include electronic circuits that include and/or are connected to one or more logic-based devices, such as microprocessors, processors, controllers, or the like. Optionally, the tunneling detection control unit 102 may represent processing circuitry such as one or more of a field-programmable gate array (FPGA), application-specific integrated circuit (ASIC), microprocessor(s), and/or the like. The circuits in various embodiments may be configured to execute one or more algorithms to perform functions described herein. The one or more algorithms may include aspects of embodiments disclosed herein, whether or not expressly identified in a flowchart or a method.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program.

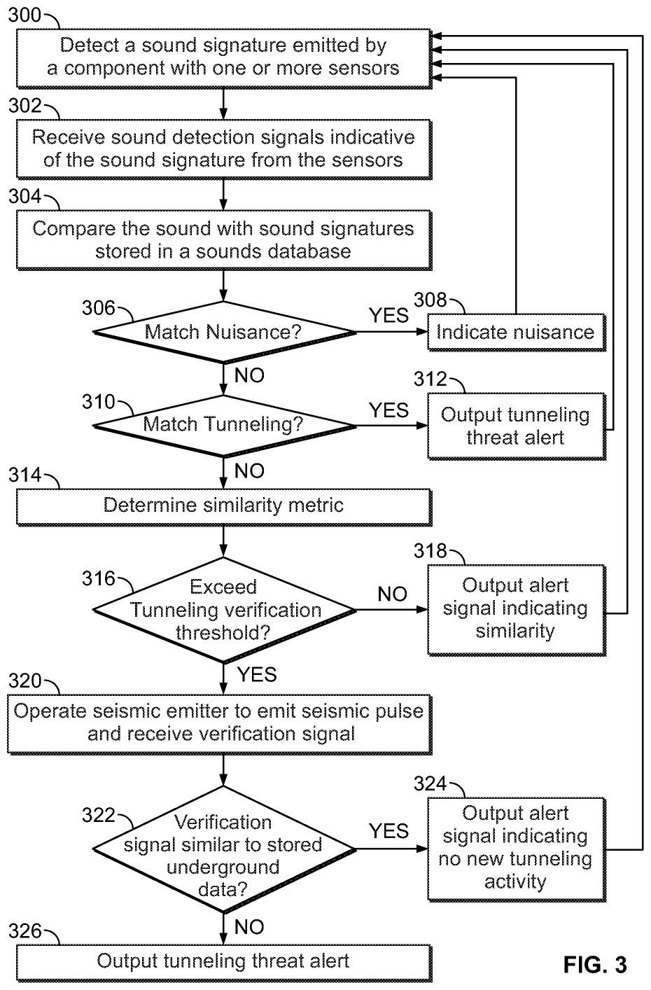

FIG. 3 illustrates a flow chart of an underground tunneling method, according to an embodiment of the present disclosure. Referring to FIGS. 1 and 3, the method beings at 300, at which the sound signature 122 emitted by the component 120 is detected by one or more sensors 104. At 302, the tunneling detection control unit 102 receives the sound detection signals 124 indicative of the sound signature 122 from the sensors 104. At 304, the tunneling detection control unit 102 compares the sound signature 122 with the sound signatures 210 stored in the sounds database 114.

At 306, the tunneling detection control unit 102 determines if the sound signature 122 matches a sound signature 210 indicative of a nuisance (that is, non-tunneling activity). If the sound signature 122 matches the sound signature 210 indicative of a nuisance, the method proceeds from 306 to 308, at which the tunneling detection control unit 102 indicates the sound signature 122 is a nuisance, and the method returns to 300.

If, however, at 306, the sound signature 122 does not match a sound signature 210 indicative of a nuisance, the method proceeds from 306 to 310, at which the tunneling detection control unit 102 determines if the sound signature 122 matches a sound signature 210 indicative of tunneling activity. If the sound signature 122 matches a sound signature 210 indicative of tunneling activity, the method proceeds from 310 to 312, at which the tunneling detection control unit 102 outputs a tunneling threat alert, and then the method returns to 300.

If, however, at 310, the sound signature 122 does not match a sound signature 210 indicative of tunneling activity, the method proceeds from 310 to 314, at which the tunneling detection control unit 102 determines a similarity metric between the sound signature 122 and one or more sound signatures 210 stored in the sounds database 114. At 316, the tunneling detection control unit 102 determines if the similarity metric exceeds a tunneling verification threshold. If the similarity metric does not exceed the tunneling verification threshold, the method proceeds to 318, at which the tunneling detection control unit 102 outputs an alert signal indicating the similarity between the sound signature 122 and the sound signature(s) 210 within the sounds database 114. An operator at the user interface 118 may then determine whether or not to operate the seismic exciter 110.

If, however, the similarity metric exceeds the tunneling verification threshold at 316, the method proceeds to 320, at which the tunneling detection control unit 102 operates the seismic exciter 110 to emit a seismic pulse 140 into the ground 106 and receive a verification signal 128 from the receiver 112 indicative of the seismic pulse 140 reflecting off internal features of the ground 106. At 322, the tunneling detection control unit 102 then determines if the verification signal 128 is similar to underground data 150 stored in the location underground database 116. If similar, the method proceeds from 322 to 324, at which the tunneling detection control unit 102 outputs an alert signal indicating no new tunneling activity (as compared to the stored underground data 150).

If, however, the verification signal 128 is not similar to the stored underground data 150, the method proceeds to 326, at which the tunneling detection control unit 102 outputs a tunneling threat alert. The verification signal 128 including data regarding the dissimilarities in relation to the underground data 150 may then be stored as an updated underground map.

As described herein, embodiments of the present disclosure provide systems and methods for detecting underground tunneling activity in relation to a location in real time. Further, embodiments of the present disclosure provide systems and methods for accurately and efficiently discerning actual underground threats from non-threats.

While various spatial and directional terms, such as top, bottom, lower, mid, lateral, horizontal, vertical, front and the like may be used to describe embodiments of the present disclosure, it is understood that such terms are merely used with respect to the orientations shown in the drawings. The orientations may be inverted, rotated, or otherwise changed, such that an upper portion is a lower portion, and vice versa, horizontal becomes vertical, and the like.

As used herein, a structure, limitation, or element that is “configured to” perform a task or operation is particularly structurally formed, constructed, or adapted in a manner corresponding to the task or operation. For purposes of clarity and the avoidance of doubt, an object that is merely capable of being modified to perform the task or operation is not “configured to” perform the task or operation as used herein.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments of the disclosure without departing from their scope. While the dimensions and types of materials described herein are intended to define the parameters of the various embodiments of the disclosure, the embodiments are by no means limiting and are exemplary embodiments. Many other embodiments will be apparent to those of skill in the art upon reviewing the above description. The scope of the various embodiments of the disclosure should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

This written description uses examples to disclose the various embodiments of the disclosure, including the best mode, and also to enable any person skilled in the art to practice the various embodiments of the disclosure, including making and using any devices or systems and performing any incorporated methods. The patentable scope of the various embodiments of the disclosure is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal language of the claims.

What is claimed is:

1. An underground tunneling detection system, comprising:
a tunneling detection control unit that receives one or more sound detection signals including a sound signature output by a component that is underground and at or proximate to a location,
wherein the tunneling detection control unit compares the sound signature to sound signature data,
wherein the tunneling detection control unit determines that the sound signature is non-tunneling activity in response to the sound signature matching a non-tunneling portion of the sound signature data,
wherein the tunneling detection control unit determines that the sound signature is tunneling activity in response to the sound signature matching a tunneling portion of the sound signature data, and
wherein the tunneling detection control unit determines a similarity metric between the sound signature and one or both of the non-tunneling portion of the sound signature data or the tunneling portion of the sound signature data in response to the sound signature differing from the sound signature data.

2. The underground tunneling detection system of claim 1, further comprising a seismic exciter and receiver in communication with the tunneling detection control unit, wherein the tunneling detection control unit is configured to operate the seismic exciter to emit a seismic pulse into the ground, wherein the seismic pulse is detected by the receiver.

3. The underground tunneling detection system of claim 2, wherein the tunneling detection control unit operates the seismic exciter to emit the seismic pulse into the ground in response to the similarity metric exceeding a tunneling verification threshold.

4. The underground tunneling detection system of claim 2, wherein the tunneling detection control unit receives a verification signal that is output by the receiver, wherein the verification signal is indicative of features of the ground as determined by the seismic pulse received by the receiver.

5. The underground tunneling detection system of claim 4, wherein the tunneling detection control unit compares the verification signal to underground data of the location.

6. The underground tunneling detection system of claim 5, wherein the tunneling detection control unit determines tunneling activity in response to the verification signal differing from the underground data.

7. The underground tunneling detection system of claim 5, further comprising a location underground database in communication with the tunneling detection control unit, wherein the location underground database stores the underground data.

8. The underground tunneling detection system of claim 1, further comprising a sounds database in communication with the tunneling detection control unit, wherein the sound signature data is stored in the sounds database.

9. The underground tunneling detection system of claim 1, wherein the sound signature data is produced at a testing facility.

10. The underground tunneling detection system of claim 1, further comprising a user interface in communication with the tunneling detection control unit, wherein the tunneling detection control unit outputs alert signals to the user interface.

11. An underground tunneling detection method, comprising:
receiving, by a tunneling detection control unit, one or more sound detection signals including a sound signature output by a component that is underground and at or proximate to a location;
comparing, by the tunneling detection control unit, the sound signature to sound signature data;
determining, by the tunneling detection control unit, that the sound signature is non-tunneling activity in response to the sound signature matching a non-tunneling portion of the sound signature data;
determining, by the tunneling detection control unit, that the sound signature is tunneling activity in response to the sound signature matching a tunneling portion of the sound signature data; and
determining, by the tunneling detection control unit, a similarity metric between the sound signature and one or both of the non-tunneling portion of the sound signature data or the tunneling portion of the sound signature data in response to the sound signature differing from the sound signature data.

12. The underground tunneling detection method of claim 11, further comprising:
operating, by the tunneling detection control unit, a seismic exciter to emit a seismic pulse into the ground; and
receiving, by a receiver in communication with the tunneling detection control unit, the seismic pulse.

13. The underground tunneling detection method of claim 12, wherein said operating comprises operating the seismic exciter to emit the seismic pulse into the ground in response to the similarity metric exceeding a tunneling verification threshold.

14. The underground tunneling detection method of claim 12, further comprising receiving, by the tunneling detection control unit, a verification signal that is output by the receiver, wherein the verification signal is indicative of features of the ground as determined by the seismic pulse received by the receiver.

15. The underground tunneling detection method of claim 14, further comprises comparing, by the tunneling detection control unit, the verification signal to underground data of the location.

16. The underground tunneling detection method of claim 15, further comprising determining, by the tunneling detection control unit, tunneling activity in response to the verification signal differing from the underground data.

17. The underground tunneling detection method of claim 15, further comprising storing the underground data within a location underground database that is in communication with the tunneling detection control unit.

18. The underground tunneling detection method of claim 11, further comprising soring the sound signature data in a sounds database that is in communication with the tunneling detection control unit.

19. The underground tunneling detection method of claim 11, further comprising producing the sound signature data at a testing facility.

20. The underground tunneling detection method of claim 11, further comprising outputting, by the tunneling detection control unit, alert signals to a user interface that is in communication with the tunneling detection control unit.
